(19) United States
(12) Patent Application Publication
(10) Pub. No.: US 2017/0236068 A1
(43) Pub. Date: Aug. 17, 2017

(54) ADJUSTING BALANCE IN CULINARY RECIPES

(71) Applicant: INTERNATIONAL BUSINESS MACHINES CORPORATION, ARMONK, NY (US)

(72) Inventors: Donna K. Byron, Petersham, MA (US); Carmine M. DiMascio, West Roxbury, MA (US); Florian Pinel, New York, NY (US); Timothy P. Winkler, Clinton, MA (US)

(21) Appl. No.: 15/194,614

(22) Filed: Jun. 28, 2016

Related U.S. Application Data
(63) Continuation of application No. 15/045,341, filed on Feb. 17, 2016.

(51) Int. Cl. G06N 99/00; G06N 5/04

(52) U.S. Cl. CPC G06N 99/005; A23L 27/00; G06N 5/048; A23V 2002/00

(57) ABSTRACT

According to one exemplary embodiment, a method for adjusting taste balance in culinary recipes is provided. The method may include receiving a template recipe, and a new recipe. The method may include determining a first taste profile corresponding with the template recipe. The method may include determining a second taste profile corresponding with the new recipe. The method may include identifying a taste to boost based on comparing the first taste profile to the second taste profile. The method may include determining a boosting ingredient from a substitution ingredients list. The method may include determining a boosting ingredient quantity based on the boosting ingredient and comparing the first taste profile to the second taste profile. The method may include determining a step alteration for the new recipe based on the boosting ingredient and the boosting ingredient quantity.

### BACKGROUND

The present invention relates generally to the field of computing, and more particularly to computer-generated culinary recipes.

With the advance of computing power, computers are being tasked with processing a wide variety of problems. Recently, computers have been used in the culinary field to produce novel culinary recipes based on inputs, such as ingredients and preferred dish style, and by searching through data repositories for existing recipe data.

### SUMMARY

According to one exemplary embodiment, a method for adjusting taste balance in culinary recipes is provided. The method may include receiving a template recipe having a first plurality of ingredients and a first plurality of recipe steps, and a new recipe having a second plurality of ingredients and a second plurality of recipe steps. The method may also include determining a first taste profile corresponding with the received template recipe based on the first plurality of ingredients. The method may then include determining a second taste profile corresponding with the received new recipe based on the second plurality of ingredients. The method may further include identifying a taste to boost based on comparing the first taste profile to the second taste profile. The method may also include determining a boosting ingredient from a substitution ingredients list based on the second plurality of ingredients and the identified taste. The method may then include determining a boosting ingredient quantity based on the determined boosting ingredient and comparing the first taste profile to the second taste profile. The method may further include determining a step alteration based on the first plurality of ingredients, the first plurality of steps, the determined boosting ingredient, the determined boosting ingredient quantity, the second plurality of ingredients, and the second plurality of ingredient steps.

According to another exemplary embodiment, a computer system for adjusting taste balance in culinary recipes is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include receiving a template recipe having a first plurality of ingredients and a first plurality of recipe steps, and a new recipe having a second plurality of ingredients and a second plurality of recipe steps. The method may also include determining a first taste profile corresponding with the received template recipe based on the first plurality of ingredients. The method may then include determining a second taste profile corresponding with the received new recipe based on the second plurality of ingredients. The method may further include identifying a taste to boost based on comparing the first taste profile to the second taste profile. The method may also include determining a boosting ingredient from a substitution ingredients list based on the second plurality of ingredients and the identified taste. The method may then include determining a boosting ingredient quantity based on the determined boosting ingredient and comparing the first taste profile to the second taste profile. The method may further include determining a step alteration based on the first plurality of ingredients, the first plurality of steps, the determined boosting ingredient, the determined boosting ingredient quantity, the second plurality of ingredients, and the second plurality of ingredient steps.

According to yet another exemplary embodiment, a computer program product for adjusting taste balance in culinary recipes is provided. The computer program product may include one or more computer-readable storage devices and program instructions stored on at least one of the one or more tangible storage devices, the program instructions executable by a processor. The computer program product may include program instructions to receive a template recipe having a first plurality of ingredients and a first plurality of recipe steps, and a new recipe having a second plurality of ingredients and a second plurality of recipe steps. The computer program product may also include program instructions to determine a first taste profile corresponding with the received template recipe based on the first plurality of ingredients. The computer program product may then include program instructions to determine a second taste profile corresponding with the received new recipe based on the second plurality of ingredients. The computer program product may further include program instructions to identify a taste to boost based on comparing the first taste profile to the second taste profile. The computer program product may also include program instructions to determine a boosting ingredient from a substitution ingredients list based on the second plurality of ingredients and the identified taste. The computer program product may then include program instructions to determine a boosting ingredient quantity based on the determined boosting ingredient and comparing the first taste profile to the second taste profile. The computer program product may further include program instructions to determine a step alteration based on the first plurality of ingredients, the first plurality of steps, the determined boosting ingredient, the determined boosting ingredient quantity, the second plurality of ingredients, and the second plurality of ingredient steps.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for adjusting recipe taste balance according to at least one embodiment;

FIG. 3 illustrates an exemplary graphical user interface (GUI) allowing a user to adjust recipe taste according to at least one embodiment;

FIG. 4 is a block diagram of internal and external components of computers and servers depicted in FIG. 1 according to at least one embodiment;

FIG. 5 is a block diagram of an illustrative cloud computing environment including the computer system depicted in FIG. 1, in accordance with an embodiment of the present disclosure; and

FIG. 6 is a block diagram of functional layers of the illustrative cloud computing environment of FIG. 5, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for adjusting taste balance in culinary recipes. As such, the present embodiment has the capacity to improve the technical field of computer-generated culinary recipes through correcting the taste of recipes by determining ingredients to add that may be compatible with the ingredients already in the base recipe. More specifically, a taste profile may be determined for the template (i.e., base) recipe, and then a taste profile may be determined for a new recipe. Thereafter, tastes that need to be boosted or masked are identified by comparing the taste profiles of the template recipe and the new recipe. Finally, one or more steps to alter in the new recipe may be determined.

As described previously, with the advance of computing power, computers are being tasked with processing a wide variety of problems. Recently, computers have been used in the culinary field to produce novel culinary recipes based on inputs, such as ingredients and preferred dish style, and by searching through data repositories for existing recipe data. However, a newly generated recipe may use different ingredients from a template (i.e., base) recipe that may affect the new recipe's taste balance. Altering the taste balance of a new recipe in comparison to the original template recipe may lead to generating an undesirable taste or take away the distinctive taste that defines the original dish.

Therefore, it may be advantageous to, among other things, provide a way to adjust the taste balance of a new recipe to match the taste balance of an original template recipe.

According to at least one embodiment, a template recipe and a list of substitute ingredients may be provided as input. Then, the template recipe may be analyzed to determine a taste profile corresponding with the template recipe. The ingredients and proportions of the ingredients may be analyzed to compute taste scores (i.e., taste magnitudes) for the five tastes (i.e., saltiness, sweetness, sourness, bitterness, and umami). For each ingredient and taste, a numeric score may be calculated. Nutrients and compounds responsible for each taste may be identified and the intensity may be retrieved from a database or other data store. A taste score may be calculated by taking the sum of the concentration multiplied by the intensity. For example, saltiness comes from potassium and sodium, sweetness comes from sucrose and other carbohydrates, etc. Furthermore, various substances have known intensities, such as sweeteners that may be compared in intensity relative to sucrose.

Next, the list of substitution ingredients may be used to generate a new recipe using known methods, such as IBM Chef Watson™ (IBM and all IBM-based trademarks and logos are trademarks or registered trademarks of International Business Machines Corporation and/or its affiliates). The newly generated recipe may then by analyzed and a taste profile may be determined as previously done to the template recipe.

The taste profiles for the template recipe and the new recipe may then be compared to identify which tastes need to be boosted or masked. Various methods may be used to choose what tastes to focus on, such as the top one or two tastes showing the largest difference (i.e., magnitude of divergence) between the two recipes (i.e., template recipe and new recipe), all tastes for which the difference exceeds a threshold value, etc. For tastes that may need to be masked, one or more other tastes may be boosted.

Next, for each taste to boost, an ingredient may be determined to be the most appropriate and the amount to use. For each taste, a list may be generated ranking the ingredients in order of contribution to that taste (since taste scores may be computed for each ingredient). Then, an ingredient to boost may be selected that best pairs with the ingredients that are already in the ingredient list. An ingredient may best pair with existing ingredients in the recipe based on the number of shared flavor compounds, by performing statistical analysis of the shared recipes, etc. Some ingredients exhibit very high scores on a single taste and may therefore be used to adjust the taste of a recipe. For example, salt for saltiness, honey for sweetness, lemon juice or passion fruit juice for sourness, bitters or cocoa powder for bitterness, and monosodium glutamate (MSG) for umami. Additionally, some tastes can partially mask each other such as saltiness and bitterness, or sweetness and sourness. However, umami may reinforce the remaining four tastes. The amount of the ingredient to use in boosting a taste may be determined based on the difference between the taste balance differences of the two recipes. An ingredient amount may be chosen that results in matching the taste balance between the two recipes.

Finally, it is determined which steps to inject new or additional ingredients in the recipe. The steps to be altered may be determined by first identifying the top contributing ingredients for the taste that may be boosted (e.g., passion fruit) in the template recipe. Next, the step where the replacement ingredient (e.g., mango) previously determined is used may be looked up in the new recipe. Finally, the taste-correcting ingredient (e.g., lemon juice) may be added to the step where the replacement ingredient (e.g., mango) is used in the replacement recipe.

According to at least one other embodiment, in addition to the five tastes, spiciness may be accounted for in the taste profiles and subsequent taste adjustments. Spiciness may be measured using the capsaicin concentration using the Scoville scale, as some dishes may also be defined based on spiciness. Other related categories may also be included such as adjusting for how mouthwatering a dish may be, or any other characteristic sensed by a receptor in the human mouth, etc.

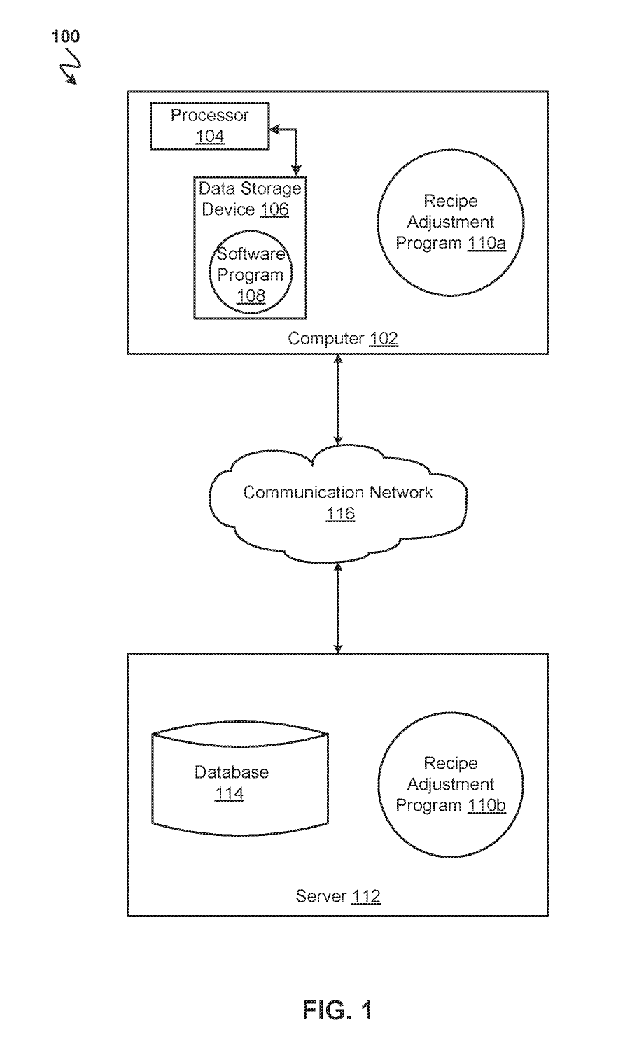

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a recipe adjustment program 110a. The networked computer environment 100 may also include a server 112 that is enabled to run a recipe adjustment program 110b that may interact with a database 114 and a communication network 116. The networked computer environment 100 may include a plurality of computers 102 and servers 112, only one of which is shown. The communication network may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

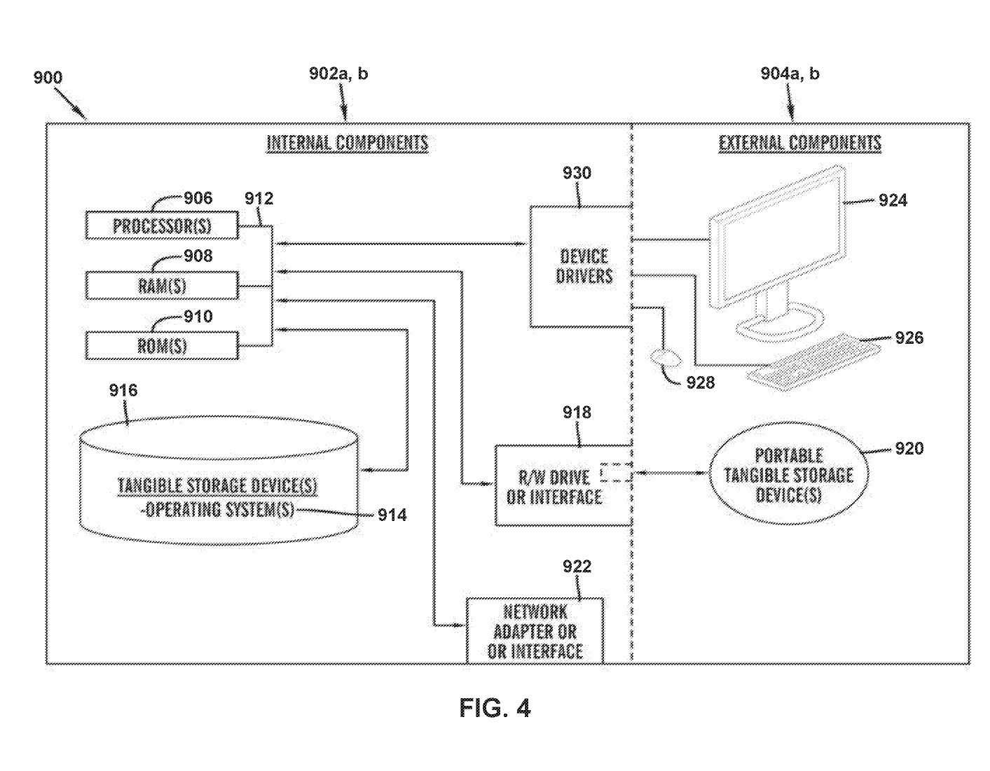

The client computer 102 may communicate with the server computer 112 via the communications network 116. The communications network 116 may include connections, such as wire, wireless communication links, or fiber optic cables. As will be discussed with reference to FIG. 4, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the recipe adjustment program 110a, 110b may interact with a database 114 that may be embedded in various storage devices, such as, but not limited to a computer/mobile device 102, a networked server 112, or a cloud storage service.

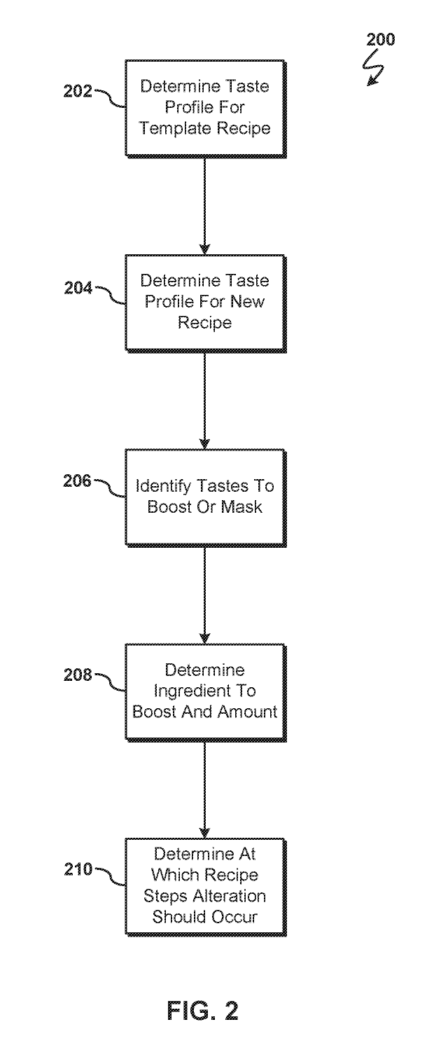

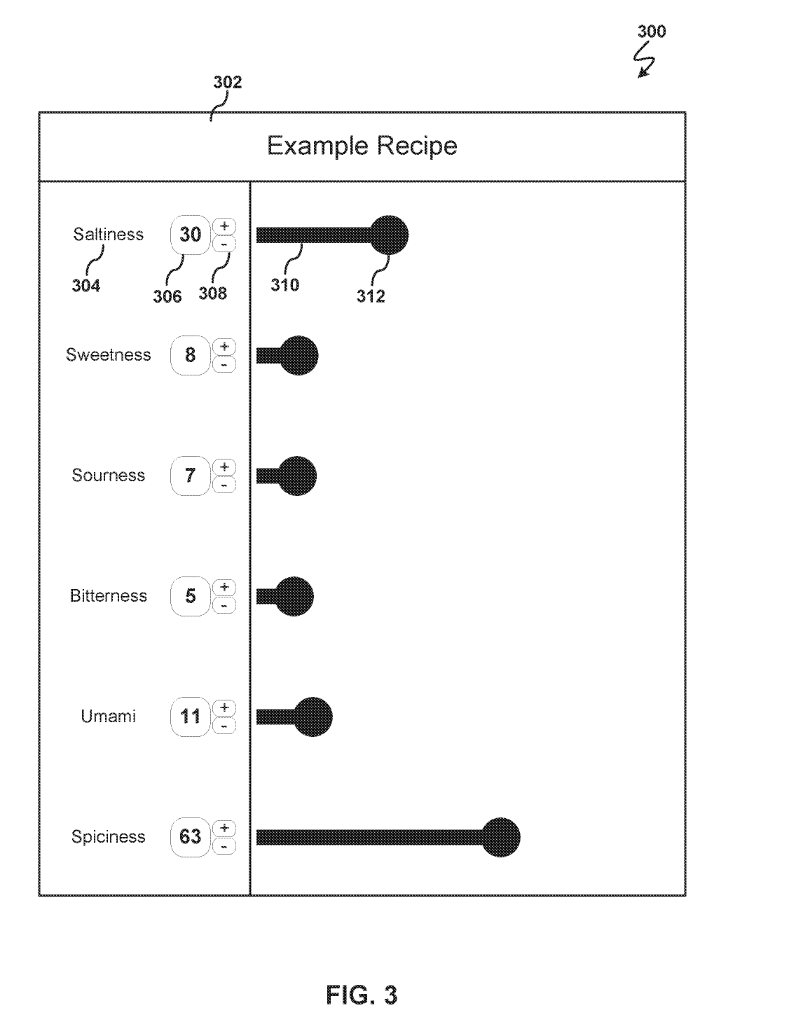

According to the present embodiment, a user using a client computer 102 or a server computer 112 may use the recipe adjustment program 110a, 110b (respectively) to adjust the taste balance of a new recipe to match the taste balance of a template recipe. The recipe adjustment method is explained in more detail below with respect to FIGS. 2 and 3.

Referring now to FIG. 2, an operational flowchart illustrating the exemplary recipe adjustment process 200 used by the recipe adjustment program 110a and 110b (FIG. 1) according to at least one embodiment is depicted.

At 202 a taste profile is determined for a template recipe. According to at least one embodiment, the recipe adjustment process 200 receives a template recipe as input, whereby the template recipe includes an ingredients list and proportions, and recipe steps. The ingredients list and proportions may then be analyzed to determine a score for each taste (i.e., saltiness, sweetness, sourness, bitterness, and umami). For each ingredient a taste score may be calculated based on the nutrients and compounds within each ingredient and known taste intensities.

For example, an ingredient's sweetness may be calculated based on the type of ingredient (e.g., an artificial sweetener) which may have a predetermined intensity (e.g., a multiplier). The intensity of various ingredients may be stored in a database (e.g., 114 (FIG. 1)) as a table that may be searched. Once the intensity is found, then the concentration of the nutrient or compound within the ingredient may be determined. The concentration may also be stored in tables in a database (e.g., 114 (FIG. 1)) or searched elsewhere based on the ingredient type and quantity required by the recipe. Based on the intensity and concentration, a score for the taste with respect to that single ingredient may be determined (e.g., an artificial sweetener may have a sweetness score of 25). The calculation for the taste score may be made by multiplying the sum of the concentration by the intensity.

All ingredients within the recipe may similarly be analyzed, and for each different taste (i.e., saltiness, sweetness, sourness, bitterness, and umami). Then the taste scores for each taste (e.g., bitterness) may be combined from all ingredients to calculate a total taste score for the template recipe. For example, if a template recipe has a quantity of cocoa powder and a quantity of citrus peel, the resulting bitterness score for the recipe may be 79. Thus, a numeric score may be obtained for each of the five tastes resulting in a taste profile for the template recipe consisting of five numeric taste scores (e.g., saltiness score=23, sweetness score=84, sourness score=3, bitterness score=4, and umami score=2).

According to at least one other embodiment, the taste profile of the template recipe may be modified to match the personal tastes of a user. A user may provide user preferences for a style of food that typically favors certain tastes. Alternatively, user data may be collected indicating that the user prefers foods with certain taste characteristics (e.g., the user prefers salty foods, so the saltiness score may be increased). Additionally, the user may be presented with a visual representation of the five taste scores and be provided with a user interface that allows the user to adjust the taste balance of the template recipe to match their personal preferences. Therefore, by altering the taste profile of the template recipe, the user may alter the subsequent new recipe later when the taste profiles are compared as will be described in detail below. The visual representation and user interface will be discussed in more detail with respect to FIG. 3.

Next, at 204, a taste profile is determined for a new recipe. According to at least one embodiment, the received template recipe may be used to generate a new recipe using known methods, such as using IBM Chef Watson™, based on a set of available ingredients and, optionally, a dish type. Additionally, manual substitution (e.g., a user does not like one or more ingredients in the template recipe and substituted in ingredients the user does like) and manually merging recipes (e.g., the user combines two or more recipes that the user likes) may be used to generate new recipes based on template recipes. The newly generated recipe may then be received by the recipe adjustment process 200 and analyzed to determine a taste profile as previously described with respect to the template recipe at 202. Thus, a set of five numeric scores may be calculated to create a taste profile for the new recipe.

Then, at 206, tastes to boost or mask in the new recipe are identified. According to at least one embodiment, the taste profiles previously determined for the template recipe and the new recipe may be compared to identify which tastes should be boosted or masked. The taste score for each taste may be compared and the difference between the two taste scores may be saved. For example, the template recipe may have a saltiness score of 33 previously determined at 202 and the template recipe may have a saltiness score of 16 previously determined at 204. Comparing the two saltiness scores results in a difference value (i.e., magnitude of divergence) of 17. Likewise, comparisons between the two recipes may be made for the remaining four tastes that may, for instance, result in difference values of 2 for sweetness, 21 for sourness, 9 for bitterness, and 4 for umami.

The tastes may then be ranked from highest difference value to lowest difference value. Continuing the above example, the ranked tastes would be in order from highest to lowest: sourness (21), saltiness (17), bitterness (9), umami (4), and sweetness (2).

According to at least one embodiment, the tastes to choose to boost or mask may be determined based on one or two tastes having the highest difference values. Continuing the above example, sourness and saltiness tastes may be chosen to boost or mask since those two tastes have the highest difference values.

According to at least one other embodiment, a predetermined threshold value may be set and any taste difference values that exceed the threshold value may be chosen to be boosted or masked. Continuing the previous example, if the threshold difference value is set to 20, then sourness would be identified as a taste to boost or mask since the sourness difference value of 21 exceeds the threshold difference value of 20. It may be appreciated that other methods to select tastes to boost or mask may be utilized or a combination of methods.

For tastes that may need to be masked, one or more other tastes may be boosted. For example, saltiness and bitterness may partly mask each other. Additionally, sweetness and sourness may partly mask each other.

At 208, one or more ingredients are selected and the amount to boost the selected ingredient is determined. According to at least one embodiment, for each taste to boost (as determined previously at 206), an ingredient may be determined out of the substitution ingredients list to be the most appropriate to use for boosting and the amount of the ingredient to boost may also be determined. For each taste, a list may be generated ranking the substitution ingredients in order of contribution to that taste (since taste scores may be computed for each ingredient). Then, an ingredient from the substitution ingredients list to boost may be selected that best pairs with the ingredients that are already in the ingredient list of the new recipe. An ingredient may best pair with existing ingredients in the new recipe using known methods, such as based on the number of shared flavor compounds, by performing statistical analysis of a corpus of existing recipes, etc.

For example, if the new recipe is for a chocolate mango cake and the template recipe is a chocolate passion fruit cake, the new recipe (i.e., chocolate mango cake) may not be as sour (i.e., acidic) as the template recipe (i.e., chocolate passion fruit cake). In order to boost the sourness of the new recipe, the ingredients in the substitution ingredients list may be searched for ingredients that are sour. Out of the substitution ingredients list, vinegar and lemon juice may be identified as sour. Upon analysis of other recipes, it may be determined that lemon juice pairs well with the ingredients used in cakes and that vinegar pairs poorly with the ingredients used in cakes. Thus, lemon juice may be selected as an additional ingredient to add sourness to the new recipe (i.e., chocolate mango cake) thereby creating a taste profile similar to the template recipe (i.e., chocolate passion fruit cake). Additionally, the amount of the ingredient required to achieve the desired taste boost may be analyzed to determine if the quantity will undesirably impact the final prepared dish (e.g., the dish's texture). For example, instead of using lemon juice to boost sourness in a cake, orange juice could be used. However, to achieve the desired sourness boost with orange juice, the quantity needed may be great and result in negatively changing the texture of the cake, whereas lemon juice may be more concentrated and have a negligible impact on the cake's texture. Thus, lemon juice may be selected over orange juice.

Some ingredients exhibit very high scores on a single taste and may therefore be used to adjust the taste of a recipe. For example, salt for saltiness, honey for sweetness, lemon juice or passion fruit juice for sourness, bitters or cocoa powder for bitterness, and monosodium glutamate (MSG) for umami. Additionally, some tastes can partially mask each other such as saltiness and bitterness, or sweetness and sourness. However, umami may reinforce the remaining four tastes. The amount of the ingredient to use in boosting a taste may be determined based on the difference value calculated previously. An ingredient amount may be chosen that results in matching the taste balance between the two recipes or results in reducing the difference value to be within a predetermined threshold.

Then, at 210, it is determined at which recipe steps the recipe alterations should occur. According to at least one embodiment, the steps to be altered may be determined by first identifying the top contributing ingredients for the taste that may be boosted (e.g., passion fruit) in the template recipe. Next, the step where the replacement ingredient (e.g., mango) is used may be looked up in the new recipe. Finally, the taste-correcting ingredient (e.g., lemon juice) may be added to the step where the replacement ingredient (e.g., mango) is used in the new recipe.

Referring now to FIG. 3, an exemplary graphical user interface (GUI) 300 allowing a user to adjust recipe taste used by the recipe adjustment program 110a and 110b (FIG. 1) according to at least one embodiment is depicted.

According to at least one embodiment, the GUI 300 may display the recipe title 302 and provide a graphical representation of the taste profile generated for the template recipe, as described previously at 202 (FIG. 2). According to at least one other embodiment, the GUI 300 may display the taste profile generated for the new recipe, as described previously at 204 (FIG. 2). The GUI 300 may display the five tastes (i.e., saltiness, sweetness, sourness, bitterness, and umami) and additionally may display spiciness as depicted. Each taste (and spiciness or other additional category) may be identified with a taste label 304. Beside the taste label 304 is the taste score 306, and a pair of adjustment buttons 308. The adjustment buttons 308 are depicted as a “+” button to increase the taste score 306 and a “−” button to decrease the taste score 306. Additionally, the taste score 306 is represented by a bar 310 with a circular end 312, whereby the length of the bar 310 is based on the magnitude of the taste score 306.

In operation, the taste score 306 associated with the taste identified by the taste label 304 (e.g., saltiness), will increase (e.g., from 30 to 31) when the user presses the adjustment button 308 to increase the taste score 306 (i.e., pressing the “+” button). Similarly, when the user presses the adjustment button 308 to decrease the taste score 306 (i.e., pressing the “−” button), the taste score 306 will be decreased (i.e., from 30 to 29). The user may interact with the adjustment buttons 308 depicted in the GUI 300 by using a mouse, keyboard, finger on a touchscreen, etc. Furthermore, when the user adjusts the taste score 306, the bar's 310 length may adjust in real-time to reflect the new taste score 306.

According to other implementations, the taste score 306 may also be edited by making the taste score 306 a text box that the user may edit and/or by allowing the user to move the bar 310. The user may move the bar 310 by pressing on the circular end 312 with a finger on a touchscreen or by clicking and holding with a mouse pointer and moving the circular end 312 left or right to adjust the length of the bar. Furthermore, the taste score 306 may change in real-time to indicate the taste score 306 corresponding with the current length of the bar 310.

By allowing the user to adjust the taste balance for a recipe through the GUI 300, the user may indicate user-preferences in taste (e.g., the user prefers saltier foods) that the recipe adjustment program 110a and 110b (FIG. 1) may use to adjust the new recipe to fit the altered recipe taste profile indicated by the user. Once the taste profile has been altered using the GUI 300, the recipe adjustment process 200 (FIG. 2) may compare the template recipe and the new recipe using the altered profile data (e.g., altered template recipe profile) as described at 206 (FIG. 2) and thereafter calculate recipe adjustments that account for the user's preferences.

It may be appreciated that FIGS. 2 and 3 provide only an illustration of one embodiment and do not imply any limitations with regard to how different embodiments may be implemented. Many modifications to the depicted embodiment(s) may be made based on design and implementation requirements. For example, in addition to the five tastes, spiciness may be accounted for in the taste profiles and subsequent taste adjustments. Spiciness may be measured using the capsaicin concentration using the Scoville scale, as some dishes may also be defined based on spiciness. Other related categories may also be included such as adjusting for how mouthwatering a dish may be, texture, etc. The GUI 300 (FIG. 3) may also be implemented as a circular shape with the taste categories divided into wedge-shaped sections with the bars 310 (FIG. 3) radiating from the center.

FIG. 4 is a block diagram 900 of internal and external components of computers depicted in FIG. 1 in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 (FIG. 1), and network server 112 (FIG. 1) may include respective sets of internal components 902a,b and external components 904a,b illustrated in FIG. 4. Each of the sets of internal components 902a,b includes one or more processors 906, one or more computer-readable RAMs 908, and one or more computer-readable ROMs 910 on one or more buses 912, and one or more operating systems 914 and one or more computer-readable tangible storage devices 916. The one or more operating systems 914 and the software program 108 (FIG. 1) and the recipe adjustment program 110a (FIG. 1) in client computer 102 (FIG. 1) and the recipe adjustment program 110b (FIG. 1) in network server 112 (FIG. 1), may be stored on one or more computer-readable tangible storage devices 916 for execution by one or more processors 906 via one or more RAMs 908 (which typically include cache memory). In the embodiment illustrated in FIG. 4, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902a,b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 (FIG. 1) and the recipe adjustment program 110a and 110b (FIG. 1) can be stored on one or more of the respective portable computer-readable tangible storage devices 920, read via the respective R/W drive or interface 918 and loaded into the respective hard drive 916.

Each set of internal components 902a, b may also include network adapters (or switch port cards) or interfaces 922 such as a TCP/IP adapter cards, wireless wi-fi interface cards, or 3G or 4G wireless interface cards or other wired or wireless communication links. The software program 108 (FIG. 1) and the recipe adjustment program 110a (FIG. 1) in client computer 102 (FIG. 1) and the recipe adjustment program 110b (FIG. 1) in network server computer 112 (FIG. 1) can be downloaded from an external computer (e.g., server) via a network (for example, the Internet, a local area network or other, wide area network) and respective network adapters or interfaces 922. From the network adapters (or switch port adaptors) or interfaces 922, the software program 108 (FIG. 1) and the recipe adjustment program 110a (FIG. 1) in client computer 102 (FIG. 1) and the recipe adjustment program 110b (FIG. 1) in network server computer 112 (FIG. 1) are loaded into the respective hard drive 916. The network may comprise copper wires, optical fibers, wireless transmission, routers, firewalls, switches, gateway computers and/or edge servers.

Each of the sets of external components 904a, bcan include a computer display monitor 924, a keyboard 926, and a computer mouse 928. External components 904a, b can also include touch screens, virtual keyboards, touch pads, pointing devices, and other human interface devices. Each of the sets of internal components 902a,b also includes device drivers 930 to interface to computer display monitor 924, keyboard 926, and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

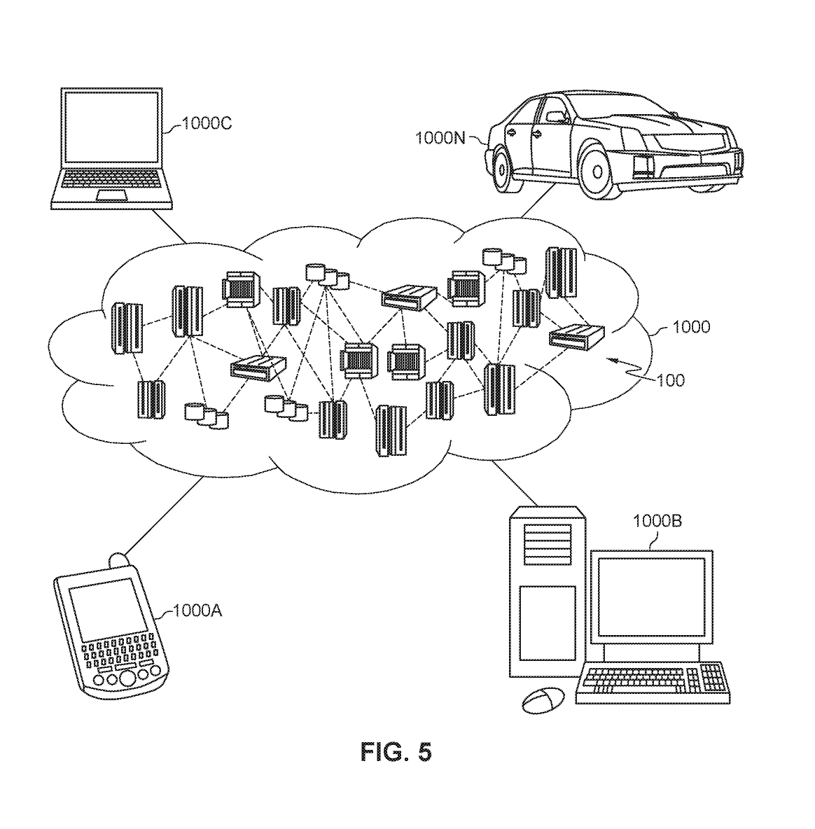

Referring now to FIG. 5, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 5 are intended to be illustrative only and that computing nodes 100 and cloud computing environment 1000 can communicate with any type of computerized device over any type of network and/or network addressable connection (e.g., using a web browser).

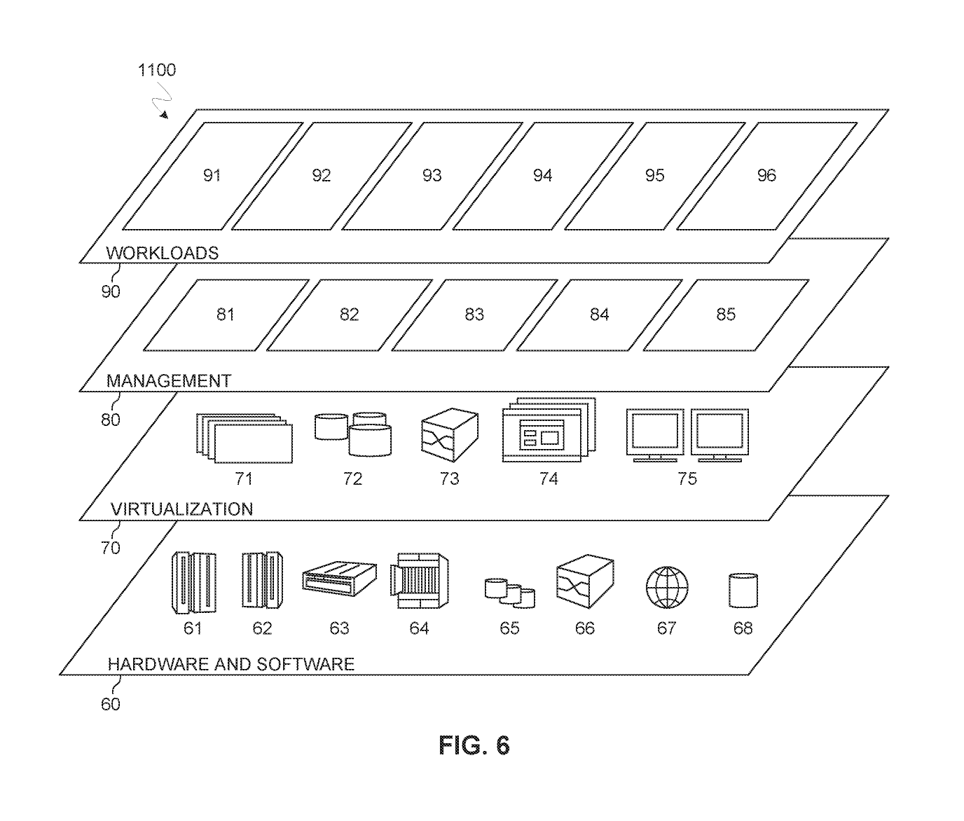

Referring now to FIG. 6, a set of functional abstraction layers 1100 provided by cloud computing environment 1000 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and recipe adjustment 96. A recipe adjustment program 110a, 110b (FIG. 1) provides a way to adjust the taste balance of a first recipe to match the taste balance of a second recipe.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for adjusting taste balance in culinary recipes, the method comprising:
receiving, by a processor, a template recipe having a first plurality of ingredients and a first plurality of recipe steps, and a new recipe having a second plurality of ingredients and a second plurality of recipe steps;
determining a first taste profile corresponding with the received template recipe based on the first plurality of ingredients;
determining a second taste profile corresponding with the received new recipe based on the second plurality of ingredients;
identifying a taste to boost based on comparing the first taste profile to the second taste profile;
determining a boosting ingredient from a substitution ingredients list based on the second plurality of ingredients and the identified taste;
determining a boosting ingredient quantity based on the determined boosting ingredient and comparing the first taste profile to the second taste profile; and
determining a step alteration based on the first plurality of ingredients, the first plurality of steps, the determined boosting ingredient, the determined boosting ingredient quantity, the second plurality of ingredients, and the second plurality of ingredient steps.

2. The method of claim 1, wherein determining the first taste profile comprises analyzing the first plurality of ingredients and determining a first set of taste scores, and wherein determining the second taste profile comprises analyzing the second plurality of ingredients and determining a second set of taste scores.

3. The method of claim 2, wherein the first set of taste scores and the second set of taste scores comprises a score for each taste category within a plurality of taste categories, wherein the plurality of taste categories includes saltiness, sweetness, bitterness, sourness, and umami.

4. The method of claim 3, wherein the plurality of taste categories further includes spiciness.

5. The method of claim 3, further comprising:
presenting a visual representation of the first taste profile to a user displaying each taste category within the plurality of taste categories.

6. The method of claim 5, wherein the visual representation allows the user to adjust a taste magnitude of each taste category within the plurality of taste categories, and wherein the first taste profile is altered to match the user's adjustments.

7. The method of claim 1, wherein identifying the taste to boost based on comparing the first taste profile to the second taste profile comprises selecting the taste that has the greatest magnitude of divergence between the first taste profile and the second taste profile.

8. The method of claim 1, wherein determining the step alteration based on the first plurality of ingredients, the first plurality of steps, the determined boosting ingredient, the determined boosting ingredient quantity, the second plurality of ingredients, and the second plurality of ingredient steps further comprises applying the determined step alteration to the second plurality of ingredient steps by adding the determined boosting ingredient in the determined boosting ingredient quantity.
